(19) United States
(12) Patent Application Publication
(10) Pub. No.: US 2007/0274808 A1
(43) Pub. Date: Nov. 29, 2007

(54) Vessel Closures and Methods Therefor

(75) Inventors: Samuel A. Martin, Sugarland, TX (US); Leslie P. Antalffy, Houston, TX (US); Kenneth D. Kirkpatrick, Sugarland, TX (US); Michael B. Knowles, Missouri City, TX (US); George A. Miller III, Needville, TX (US); George T. West, Houston, TX (US)

Correspondence Address: FISH & ASSOCIATES, PC;ROBERT D. FISH, 2603 Main Street, Suite 1050, Irvine, CA, 92614-6232, US

(73) Assignee: FLUOR CORPORATION, Aliso Viejo, CA (US)

(21) Appl. No.: 10/492,756

(22) PCT Filed: Oct. 17, 2002
(86) PCT No.: PCT/US02/33576

§ 371 Date: Jul. 20, 2007

Related U.S. Application Data
(60) Provisional application No. 60/330,236, filed on Oct. 17, 2001.

(51) Int. Cl. B65G 25/00

(52) U.S. Cl. 414/160

(57) ABSTRACT

Configurations and methods are provided in which a bottom head is coupled to a coke vessel via a conveyor and an elevator such that the elevator moves the bottom head vertically relative to the coke vessel, and the conveyor moves the bottom head along a curved path. Contemplated configurations are especially advantageous where a coke vessel deheading device has a hinged or swing-away head and wherein the head and the vessel have a close-fit diametrical tolerance fit.

This application claims priority to U.S. provisional patent application with the Ser. No. 60/330,236, which was filed on Oct. 17, 2001 and is incorporated by reference herein.

### BACKGROUND OF THE INVENTION

High-pressure vessel closures, and especially coke vessel bottom heads pose a significant danger to an operator during manual and inadvertent opening of vessel. Consequently, numerous configurations and methods have been developed to automate deheading and reheading operation of coke vessels, and various automation approaches are known in the art.

For example, in one approach the bottom head is lowered from the coke vessel and laterally removed from the coke vessel using a rail or cart as described in U.S. Pat. No. 5,581,864 to Rabet, U.S. Pat. No. 5,228,825 to Fruchtbaum et al., and U.S. Pat. No. 6,022,454 to Fetzer, all of which are incorporated by reference herein. While such configurations are typically relatively reliable, the space requirements for operation of the rail or cart may often prohibit implementation of such configurations. To circumvent at least some of the problems associated with such configurations, the bottom head may be tilted after removal from the coke vessel as described in U.S. Pat. No. 5,500,094 to Fruchtbaum et al., also incorporated by reference herein.

In another approach, bottom head remains coupled to the coke vessel and is swung out of the way using a hinge, pivot, or otherwise rotatable element. Exemplary configurations for such deheading devices are described, for example, in U.S. Pat. No. 5,098,524 to Antalffy et al., which is incorporated by reference herein. Alternatively, and especially where the headroom of the bottom head is relatively limited, use of a trammel pivot for pivotally moving the bottom head may advantageously be employed as U.S. Pat. Nos. 5,785,843 and 6,264,829, to Antalffy et al., both of which are incorporated by reference herein.

While all or almost all of the known systems provide at least some improvement over previously known methods and configurations, various difficulties still remain. Most significantly, in order to provide consistent and reliable gasket seating during subsequent reheading operations, many configurations employ a close-fit diametrical tolerance fit between the bottom drum head and the deheading device. While such configurations typically ensure repeatable gasket seating characteristics each time the head is introduced to the drum flange, the head, once diametrically engaged with the deheading device, must approach the drum flange in a motion that maintains parallelism between the head and the drum flange. Unfortunately, however, most known close-tolerance heads will tend to jam in the deheading device receptacle as the head is approaching the drum flange for reheading and gasket seating, or retracting from the drum flange during deheading.

Thus, although there are various vessel closures, and especially coke vessel deheading devices, known in the art, all or almost all of them suffer from one or more disadvantages. Therefore, there is still a need to provide improved methods and configurations for vessel closures, and especially coke vessel deheading devices.

### BRIEF DESCRIPTION OF THE DRAWING

FIG. 1 is an exemplary configuration of coke vessels with improved deheading devices.

FIG. 2A is an exemplary configuration of a contemplated deheading device with the head in closed position.

FIG. 2B is an exemplary configuration of a contemplated deheading device with the head in open position.

### SUMMARY OF THE INVENTION

The present invention is generally directed to improved vessel closures, and especially to improved coke vessel deheading devices.

In one particularly preferred aspect of the inventive subject matter, a bottom head is coupled to a coke vessel via a conveyor and an elevator, wherein the elevator moves the bottom head in a first movement vertically relative to the coke vessel, and wherein the conveyor moves the bottom head along a curved path in a second movement.

Preferred bottom heads are coupled to the elevator such that the bottom head moves laterally relative to the coke vessel, and it is especially preferred that the lateral movement is a movement along a single (or two) horizontal axis relative to the coke vessel. It is further contemplated that the elevator comprises an elevator deck to which the bottom head is removably coupled, and that the movement of the head is provided by an actuator coupled to the coke vessel.

In another particularly preferred aspect, the conveyor is coupled to the coke vessel via a pivot or a compound pivot. Therefore, it is generally contemplated that the curved path is a circular or non-circular path. Contemplated configurations are particularly useful where the head closes a bottom opening of the coke vessel in a close-fit diametrical tolerance fit.

Consequently, a method of constructing a coking vessel will have one step in which a bottom head, a conveyor, and an elevator are provided. In a further step, the bottom head is coupled to the coke vessel using the conveyor and the elevator such that the elevator moves the bottom head vertically relative to the coke vessel, and the conveyor moves the bottom head along a curved path.

Various objects, features, aspects and advantages of the present invention will become more apparent from the following detailed description of preferred embodiments of the invention, along with the accompanying drawings in which like numerals represent like components.

### DETAILED DESCRIPTION

The inventors have discovered that automated deheading and reheading of a coke vessel can be achieved in a manner that ensures reliable and consistent gasket sealing when the bottom head is removed from the vessel in a first movement following a non-curved path, and then moved in a second movement from the coke vessel following a curved path.

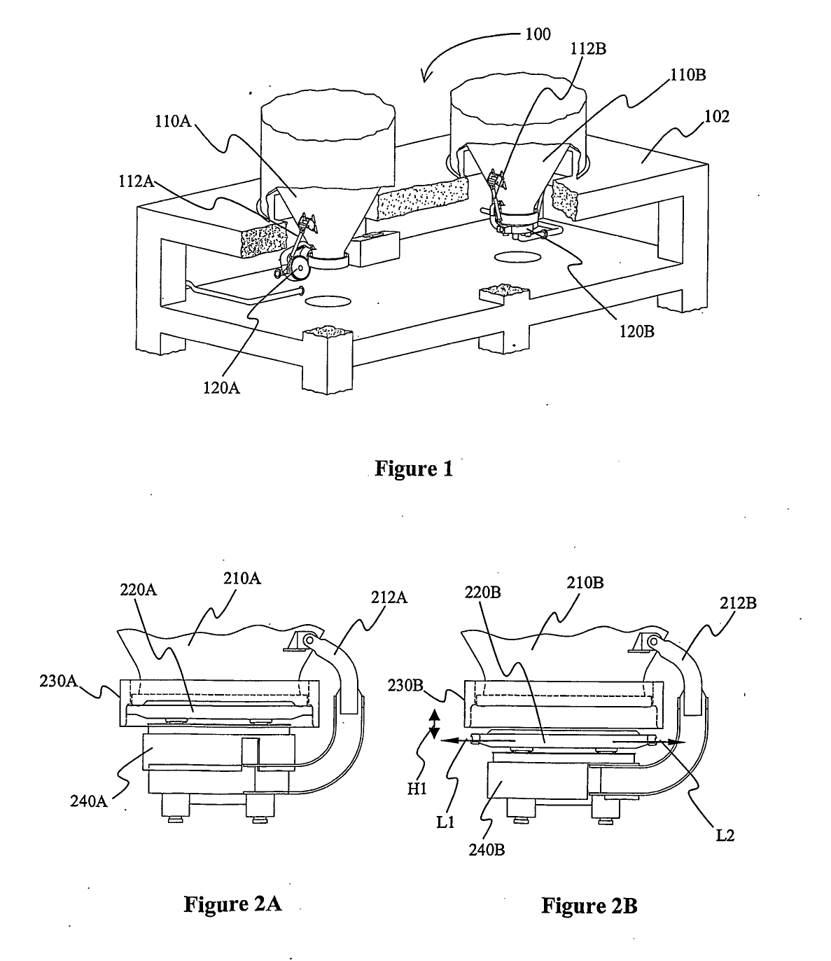

More particularly, a bottom head is coupled to the coke vessel via a conveyor and an elevator in especially preferred coking vessels, wherein the elevator moves the bottom head vertically relative to the coke vessel, and wherein the conveyor moves the bottom head along a curved path. An exemplary configuration 100 of contemplated coking vessels is depicted in FIG. 1, in which a first coking vessel 110A on platform 102 has a deheading device 120A in an open position, wherein the deheading device 120A is actuated by hydraulic actuator 112A. Similarly, the second coking vessel 110B on platform 102 has a deheading device 120B in a closed position, wherein the deheading device 120B is actuated by hydraulic actuator 112B.

A more detailed view of the configuration of the closed vessel (110B) of FIG. 1 is shown in FIG. 2A, in which vessel 210A is coupled to the bottom head 220A, wherein the bottom head 220A closes the opening of the vessel, and wherein the ring element 230A provides a close-fit diametrical tolerance fit for the bottom head 220A. Conveyor 212A is pivotally coupled to the vessel 210A and further comprises elevator 240A to which the bottom head 220A is latched.

When the vessel is opened, the elevator 240B is vertically lowered as depicted by the arrow H1 in FIG. 2B. Here, vessel 210B is again coupled to the bottom head 220B, wherein the bottom head 220B is lowered within and below the ring element 230B via elevator 240B. It should be particularly appreciated that the bottom head 220B is coupled to the elevator 240B (or the conveyor 212B) such that the bottom head 220B has at least one, and more preferably two degrees of lateral motional freedom (i.e., along an X-axis and/or a Y-axis, which are substantially perpendicular to the axis of vertical movement) as indicated by the arrows L1 and L2. Opening of the coke vessel is completed by pivoting the conveyor 212B (to which the elevator 240B and the bottom head 220B are coupled) such that bottom head is clear of the path of the coke (not shown) leaving vessel 210B.

With respect to the vessel, it should be recognized that various vessels other than a coking vessel are also appropriate, and particularly contemplated alternative vessels include vessels that operate under elevated pressure (relative to atmospheric pressure). For example, suitable vessels include fermentation vessels, chemical reactors, and food processing reactors. However, especially preferred vessels include coking vessels (e.g., delayed coking vessel).

Consequently, the particular nature of contemplated bottom heads will vary depending on the particular type of vessel. For example, in one aspect of the inventive subject matter where the vessel is a coke vessel, contemplated bottom heads will generally be fabricated from a material with sufficient mechanical and thermal strength to resist the pressure and heat in the coking vessel. Therefore, particularly suitable materials will include steel and composite materials comprising steel. Moreover, suitable bottom heads may further include (or be configured to cooperate with) a seal or gasket, and it is especially preferred that the bottom head closes a bottom opening of the coke vessel in a close-fit diametrical tolerance fit. Close-fit diametrical tolerance fit may be provided in various manners well known to a person of ordinary skill in the art, and all such manners are considered suitable for use herein. For example, a close-fit diametrical tolerance fit may be achieved via a ring coupled to the opening of the vessel as depicted in FIGS. 2A and 2B. Alternatively, suitable close-fit diametrical tolerance fits may also be achieved using a lock ring as described in U.S. Pat. No. 5,048,876 to Wallskog, in which the ring further includes rollers that provide (at least in part) a closing force on the non-mating sides of the flanges.

Still further, it is contemplated that the bottom head may include an opening that is fluidly coupled to a conduit that connects with a pipe through which the vessel can be filled when the bottom head is in a closed position. There are numerous bottom heads known in the art, all of which are considered suitable for use herein. Exemplary bottom heads are depicted in U.S. Pat. No. 5,336,375 to Wallskog et al., U.S. Pat. No. 6,039,844 to Malik, and U.S. Pat. No. 6,022,454 to Fetzer, all of which are incorporated by reference herein.

In another example, where the vessel is a fermentation vessel or chemical reactor, it is contemplated that the bottom head may manufactured from a material that is sterilizable and/or exhibits sufficient chemical strength to resist sterilization conditions (e.g., steam, radiation, or gas) and/or solvents in the vessel. Therefore, particularly suitable materials will include glass, synthetic polymers, stainless steel, and all reasonable combinations thereof. Moreover, such bottom heads may further include (or be configured to cooperate with) a seal or gasket, sample retrieval and/or addition ports, or ports for probes (e.g., pH, thermometer, turbidity, metabolites, etc.).

It is further generally preferred that suitable bottom heads are movably coupled to the vessel via a conveyor such that the conveyor moves the bottom head along a curved path. For example, contemplated conveyors may comprise an arm having at least two ends, wherein the elevator with the bottom head is coupled on one end, and wherein the other end is rotatably coupled to the vessel (see e.g., U.S. Pat. No. 5,098,524 to Antalffy et al.). Consequently, the bottom head in such configurations will (absent further degrees of rotational freedom in the conveyor) generally follow a circular path. On the other hand, and especially where the head space is relatively limited, contemplated conveyors may comprise an arm having at least two ends, wherein the elevator with the bottom head is coupled on one end, and wherein the other end is coupled to the vessel via a compound pivot (see e.g., trammel pivot in U.S. Pat. No. 6,264,829, to Antalffy et al). Therefore, the bottom head in such configurations will (absent further degrees of rotational or translational freedom in the conveyor) generally follow a non-circular path (here: elliptic).

Suitable conveyors may be fabricated from numerous materials, and it is contemplated that the choice of material will predominantly depend on the particular mechanical and/or thermal requirements. Therefore, suitable materials will include various metals, metal alloys, natural and synthetic polymers, and all reasonable combinations thereof. With respect to the number of conveyors, it should be recognized that the number of conveyors is not limiting to the inventive subject matter so long as the conveyor moves the bottom head along a curved path. Consequently, the number of conveyors will typically be between one and four, and even more.

Still further, it should be recognized that the conveyor may be coupled to the vessel in numerous manners, including permanent and non-permanent manners. For example, where it is expected that the conveyor requires replacement or off-site maintenance, it is generally preferred that the conveyor is removably (e.g., bolted, screwed, etc.) coupled to the vessel. On the other hand, suitable couplings may also include welding, and it is further contemplated that at least part of the conveyor may be an integral part of the vessel.

Therefore, it should be recognized that the conveyor may be actuated using one or more of various mechanisms, and especially contemplated mechanisms include manual, automatic and/or remote actuation. For example, manual actuation includes an operator that manually moves the conveyor from a first to a second position (which may be assisted by cable winch). However, it is generally more preferred that the actuation of the conveyor includes an automatic, and most preferably a remote automatic process. Such automated actuations will typically include a hydraulic or pneumatic cylinder. Alternatively, automated actuation may also include a motor (e.g., an electric motor) coupled to one or more cables that move the conveyor. There are numerous manners for actuating a conveyor known in the art, and all of these manners are considered suitable so long as such manners will result in the conveyor moving the bottom head along a curved path. The term “moves the bottom head along a curved path” as used herein refers to movement of the bottom head along an imaginary line that follows a segment of a circle or ellipse.

With respect to the elevator it is generally contemplated that (a) the bottom head is coupled to the elevator and (b) that the elevator moves the bottom head vertically relative to the coke vessel. The term “vertical[ly] relative to the coke vessel” as used herein refers to a straight upwards or downwards movement in an angle substantially 90 degree (i.e., deviation no more than ±10 degrees, and more typically no more than 5 degrees) relative to an absolute horizontal plane.

There are numerous configurations in which the bottom head may be coupled to the coke vessel via the elevator and the conveyor, and all of such couplings are contemplated suitable for use herein. For example, in one contemplated configuration, the elevator and the conveyor are coupled such that the elevator is movably attached to the vessel and moves both the conveyor and the bottom head. Such configurations may be particularly suitable where an existing coke vessel is retrofitted with a device according to the inventive subject matter. On the other hand, it is also contemplated that the elevator and the conveyor are coupled such that the elevator is movably attached to the conveyor as depicted in FIGS. 2A and 2B. Such configurations may be particularly advantageous where more than one conveyor is coupled to a single elevator.

Depending on the manner of coupling the conveyor to the elevator, it should be recognized that numerous manners of vertically moving the elevator are considered appropriate herein, and especially contemplated manners of vertically moving the elevator include manual, automatic, and/or remote actuation, and any reasonable combination thereof. For example, an operator may remotely and automatically (e.g., via hydraulic, pneumatic, or electric motor) move the elevator in a downwards movement when the coke vessel is deheaded. Upon reheading, the operator may then manually (e.g., using a crank or other lifting device) move the elevator in an upwards movement, which is especially advantageous where the operator further manipulates the bottom head to adjust the bottom head in a lateral movement. Alternatively, movement of the elevator may be entirely remote-controlled and automatic where it is particularly desirable that the operator remains in a distance that reduces inadvertent exposure to at least part of the vessel contents.

In an especially contemplated aspect of the inventive subject matter, the elevator comprises an elevator deck that is hydraulically actuated (e.g., by coupling the deck to the vessel via a hydraulic cylinder), and further comprises a mechanism that allows lateral movement of the bottom head while the bottom head is coupled to the elevator. For example, suitable mechanisms may include guide rails or gears (e.g., coupled to either the bottom head or the elevator), which may be manually or automatically actuated. It is further generally contemplated that lateral movement of the bottom head includes not only lateral movement along one space coordinate (e.g., x-coordinate) but may also include lateral movement along two space coordinates (e.g., x- and y-coordinate). The term “lateral movement” as used herein refers to a side-to-side and/or front-to-back movement of the bottom head when the bottom head is coupled to the elevator. In yet further contemplated aspects, it should be recognized that the bottom head may be removably (e.g., latched) or permanently (e.g., bolted) coupled to the elevator.

Therefore, it should be recognized that contemplated configurations will provide a consistent and reliable gasket seating during subsequent reheading operations (and especially in combination with a close-fit diametrical tolerance fit between the bottom drum head and the deheading device) by providing a first vertical movement of the bottom head followed by a second movement of the bottom head that follows a curved path, thereby maintaining parallelism between the head and the drum flange as the head approaches the opening or is disengaged from the opening.

Consequently, a method of constructing a coking vessel may include a step in which a bottom head, a conveyor, and an elevator are provided. In a second step, the bottom head is coupled to the coke vessel using the conveyor and the elevator such that the elevator moves the bottom head vertically relative to the coke vessel, and the conveyor moves the bottom head along a curved path. With respect to the coking vessel, the bottom head, the conveyor, the elevator, the coupling, and the movements of the bottom head, the same considerations as described above apply.

Thus, specific embodiments and applications of improved configurations and methods for vessel closures have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A chemical reactor comprising a bottom head coupled to the chemical reactor via a conveyor and an elevator, wherein the elevator moves the bottom head vertically relative to the chemical reactor, wherein the conveyor is movably coupled to the chemical reactor via a pivot or a compound pivot such that the bottom head moves along a curved path, and wherein the bottom head is laterally movably coupled to the elevator.

2. (canceled)

3. The chemical reactor of claim 1 wherein lateral movement comprises movement along a single horizontal axis relative to the chemical reactor.

4. The chemical reactor of claim 1 wherein the elevator comprises an elevator deck to which the bottom head is removably coupled.

5. The chemical reactor of claim 1 wherein at least one of the movement of the head along a curved path and the vertical movement is provided by an actuator coupled to the chemical reactor.

6. (canceled)

7. The chemical reactor of claim 1 wherein the curved path is a circular path.

8. The chemical reactor of claim 1 wherein the head closes a bottom opening of the chemical reactor in a close-fit diametrical tolerance fit.

9. A method of constructing a chemical reactor, comprising:
providing a bottom head, a conveyor, and an elevator;
coupling the bottom head to the chemical reactor using the conveyor and the elevator such that the elevator moves the bottom head vertically relative to the chemical reactor, and the conveyor moves the bottom head along a curved path;
wherein the conveyor is coupled to the chemical reactor via a pivot or a compound pivot; and
movably coupling the bottom head to the elevator such that the bottom head moves laterally relative to the elevator.

10. (canceled)

11. The method of claim 9 wherein lateral movement comprises movement along a single horizontal axis relative to the chemical reactor.

12. The method of claim 9 wherein the elevator comprises an elevator deck to which the bottom head is removably coupled.

13. The method of claim 9 wherein movement of the head is provided by an actuator coupled to the chemical reactor.

14. (canceled)

15. The method of claim 9 wherein the curved path is a circular path.

16. The method of claim 9 wherein the head closes a bottom opening of the chemical reactor in a close-fit diametrical tolerance fit.
